(19) United States
(12) Patent Application Publication
(10) Pub. No.: US 2018/0053092 A1
(43) Pub. Date: Feb. 22, 2018

(54) Method and System for Innovation Management and Optimization Under Uncertainty

(71) Applicant: Yasin Hajizadeh, Houston, TX (US)

(72) Inventor: Yasin Hajizadeh, Houston, TX (US)

(21) Appl. No.: 15/682,946

(22) Filed: Aug. 22, 2017

Related U.S. Application Data
(63) Continuation of application No. 15/488,512, filed on Apr. 16, 2017.
(60) Provisional application No. 62/377,692, filed on Aug. 22, 2016.

(51) Int. Cl. G06N 3/08; G06N 7/00; G06N 5/02; G06F 17/30

(52) U.S. Cl. CPC G06N 3/08; G06N 7/005; G06N 5/022; G06F 17/30424; G06F 17/30598

(57) ABSTRACT

An integrated and comprehensive method and system is disclosed for management and optimization of innovation and associated processes under uncertainty. A first embodiment of the invention consists of a data mining and clustering module to compare a new innovation submission with existing internal and external entries and databases, identify similarities and group similar entries together. A second embodiment of the invention is directed towards an intelligent machine learning module to learn from the available data of previous innovation projects and provide estimates of outputs or target values for new innovation submissions or entries. In a third embodiment of the invention, an uncertainty quantification method and system is introduced to handle uncertain inputs of innovation entries and provide probabilistic estimates of outputs by generating a plurality of solutions and scenarios. In a fourth embodiment of the invention, a multiobjective optimization module is used to simultaneously optimize multiple competing objectives.

### CROSS REFERENCE TO RELATED APPLICATIONS

This application is a continuation of U.S. patent application Ser. No. 15/488,512, filed on Apr. 16, 2017, which claims the benefits of the filing date of and priority to U.S. Provisional Application Ser. No. 62/377,692 entitled “Method and System for Innovation Management and Optimization under Uncertainty” and filed Aug. 22, 2016, the entire contents of each of which are herein incorporated by reference.

### FIELD OF THE INVENTION

The invention described herein is related to aspect of computer assisted methods, workflows, systems and apparatuses for classification, clustering, analytics, uncertainty quantification, optimization and visualization of innovation entries. An innovation entry is defined as any innovation idea related to products and services, conceptual designs, research and development processes, enhancement requests, emerging technologies and roadmaps and alike. It is directed towards facilitating innovation and technology management and development in organizations.

### BACKGROUND OF THE INVENTION

Organizations are under constant pressure to come up with innovative products and services, shorten the time between ideas and markets, increase product and service quality, maximize profits and minimize costs and environmental impacts. A solid and cohesive innovation and technology management platform is the main tool for organizations to achieve these objectives. Very often employees come up with innovative ideas and product concepts which should be transformed from being a market opportunity to new products and/or services. Organization also receive a constant stream of requests from their customers for new features or enhancements of existing offerings. It is becoming increasingly evident that companies can create strategic advantages by implementing a systematic workflow to innovation and technology management. A well-managed pipeline of products and services can result in a higher probability of success, reduced costs and optimized investment decisions.

The first challenge of achieving an integrated system is to categorize and classify large amounts of data related to innovation and technology ideas and submission that is currently stored in an organization's systems and archives. It is also a challenging task to receive, handle, review and decide on new innovation entries and data coming from employees and customers. This is important from two perspectives. First, each idea and concept must be filtered according to various criteria set by organizations, so they can be forwarded to appropriate sections and decision makers. Second, there is a large risk that two or more groups in the same organization work on similar projects without a knowledge of parallel internal or external efforts. An automated system can help to categorize ideas and detect similarities between them to minimize this risk. By avoiding to work on similar or parallel projects, significant cost and time savings can be achieved for organizations.

Furthermore, several innovation or development portfolios in a company may compete for a fixed budget. Selecting right portfolios to deliver optimized pipelines of products and services can be an extremely challenging task for the decision makers. Scarce resources must be deployed on more efficient products and services to increase the development efficiency. Real-life optimization problems deal with multiple objectives which are often conflicting. An example of conflicting objectives is speed of delivering a project vs. project cost. The common practice to tackle optimization problems is to use a priori methods. A priori methods focus on relative importance of objectives and user's input to specify a preference before initializing the optimization algorithm. The dominating approach this category is the weighted sum method in which objective functions are scalarized to form a single objective function using weight factors. The main drawbacks of this approach include cumbersome task of determining weight factors, dependence of weights on the scale of individual objective functions, inability to handle problems with a non-convex Pareto front (Das and Dennis, 1997) and the need to try multiple weight factors in dealing with convex Pareto fronts. Decision makers may, in fact, miss a single or multiple solutions that would have addressed the conflicting nature of business objectives using a weighted-sum approach. Finally, all of the optimization workflows must take into consideration uncertainty surrounding technical and economical aspects of a project. It has been shown that no single correct measurement of project costs exists; but multiple measures must be aggregated to achieve realistic estimates (DeMillo and Lipton, 1980). Therefore, existing solutions to innovation management that use a single model to arrive at economical, technical or operational numbers without considering inherent uncertainty in them are bound to fail in addressing real-world challenges.

U.S. Pat. No. 7,533,035 B1, published May 12, 2009 by Abend et al., discloses a method and system to manage exchange, and apply innovation related IT data. The method receives data from several sources, qualifies data inputs, selects one or more of the qualified data inputs, selects at least one innovation technique and applies the selected innovation technique to the selected data input. The system provides an innovation engine which maps the applications for innovation into a carefully organized bank of proven processes that are presented in tables 1-A, 1-B, 2, 3 and 4 of the patent. It does not disclose any automated idea mining and clustering, optimization and uncertainty management algorithms and workflows for this process.

U.S. Pat. Application US 2010/0191579A1, published Jul. 29, 2010 by Sudarshan et al., presents a method for improving product effectiveness of a New Product Development (NPD) process by customizing a Product Lifecycle Management (PLM) of an organization. The method works by diagnosing current status of the organization with respect to one or more product effectiveness parameters and generates a set of initiatives for the organization based on the diagnosis. The method further comprises customizing the PLM using one or more solution accelerators corresponding to one or more initiatives. This application focuses on current status of the organization using a diagnostics module and computes a product effectiveness index for existing products. No attempt is made to work with new innovation or technology ideas and submissions, processes and workflows.

U.S. Pat. Application US 2010/0205025 A1, published Aug. 12, 2010 by Johansen, demonstrates an innovation management system with a focus on innovation campaigning. The system includes a database with user profiles and means for receiving ideas from users, means for receiving input providing information about ideas, means for handling and categorizing the ideas adapted to use the input, means for providing a set of process steps based on the categorization, means for storing the received, handled and categorized ideas, means for distributing the ideas to the other users of the community and means for enabling the users to process and evaluate the ideas. A limitation of the patent as filed is that it relies on categorization of the ideas based on predefined user criteria and no automated mechanism is presented to compare, categorize and optimize the inputs considering various constraints. Furthermore, the input information including implementation costs, rewards and revenues (e.g. FIG. 8 of the disclosure) are only entered using single numerical values, ignoring the uncertainty in, for example, the economics of the idea.

U.S. Pat. Application US 2006/0178928 A1, published Aug. 10, 2006 by Carney et al., discloses a method, system and computer software tool for capturing innovation. The software tool comprises a means for entering an innovation into a database, and a system for evaluating said innovation. A key drawback of the system as disclosed (i.e. [0027]) is that the evaluation is performed by team members either ad hoc or in response to a request from the queue manager. No algorithmic or automated approach is presented for evaluation, comparison and optimization of the inputs with or without uncertainty.

U.S. Pat. Application US 2007/0276675 A1, published Nov. 29, 2007 by Gabrick et al., demonstrates an innovation management system, apparatus and method that associates information with innovations provided to the system. The information is stored in a storage device. Embodiments also receive descriptions of innovations provided by users and/or provide those innovation descriptions to other users. In this disclosure, a system is presented for searching the database for innovations. However the search (i.e. FIG. 14 of the disclosure) is performed manually by entering keywords instead of an automated system using data and text mining, analytics or machine learning to discover similar system entries without human intervention or minimal user interaction.

U.S. Pat. No. 7,584,117 B2, published Sep. 1, 2009 by Bubner, presents a method for determining a business's innovation capability consists of using a computer and internet based system. The disclosed system has a questionnaire program to obtain answers relating to six foundation capabilities and six innovation capabilities which are then weighted and transformed by an algorithm into a value index. The index is used by management and investors to forecast future growth and profitability of the business. The method is based on conducting a survey over a computer network of managers and employees. The disclosure does not consider applying an algorithmic metric to individual ideas in order to compare, classify or optimize the portfolio of innovation ideas.

U.S. Pat. Application US 2004/0181417 A1, published Sep. 16, 2004 by Piller et al., presents a system and techniques to facilitate collaborative development of product innovation ideas. The technique includes receiving product innovation ideas via a network and storing the product innovation ideas. The stored product innovation ideas are displayed for review by a user, and the user may send an indication via network of one or more selected product innovation ideas. In the disclosure (i.e. [0084]), a user browses a list of ideas submitted by others and can only manually search for similar ideas (i.e. step 2220 and 2225). Furthermore the evaluation process of ideas is based on collaboration of two or more team members (i.e. step 2315) without using any numeric or similarity metric entered by a user or calculated by an algorithm, considering uncertainty and risk.

U.S. Pat. No. 6,944,514 B1, published Sep. 13, 2005 by Matheson, documents an innovation information management data tracking object model and interface which captures and stores product ideas, requirements, constraints, design alternatives and functions, along with their associated relationships. No attempt is made in this invention to define metrics for inputs and outputs, optimize portfolio of innovation ideas and/or automatically compare and classify the entries.

U.S. Pat. Application US 2014/0095250 A1, published Apr. 3, 2014 by Hayes et al. discloses a system and method for facilitating management of innovations and accompanying constituent concepts. In this invention, users can define metrics such as supply chain risk, measurement of cost associated with a concept, compliance measurement, manufacturer qualification, etc. Users can visualize different innovation ideas based on the metrics. There are two major limitations for the invention as disclosed in the patent application. First limitation is with regards to the selection of alternative solutions (i.e. FIG. 1C) and that no optimization routine and algorithm is considered in arriving at optimal solutions. Users have to choose between either the low cost or high speed solutions that are calculated using pre-defined metrics. Using a multiobjective optimization approach, as it will be disclosed later on in this document, will solve this issue by presenting a Pareto front for optimized objectives. Users are able to select optimal solutions considering two (e.g. cost vs. speed) or more objective functions simultaneously. The second limitation arises from ignoring uncertainty in the metrics. For example, economic variables (e.g. target cost as disclosed in FIG. 1D) are assigned a single value or number. The current invention solves this issue by defining a probability distributions for metrics and presents the target outputs in the form of a range, rather than a single numerical value.

As such, there remains a need for a system, method and computer readable medium capable of assisting users with innovation and technology management operation and in selecting the most promising entries to develop new technologies, products or services in any field or industry.

### SUMMARY OF THE INVENTION

Accordingly, this document discloses a system and method for automated categorization and classification of innovation entries. In order to accomplish this, an innovation gathering system is used where a user interacts with the system via an interface to input ideas and innovations. Example inputs can be of different media types including text, audio, images, videos, and alike. In one embodiment, data from previous ideas, technologies, innovations or projects may be captured and analyzed in order to identify similar metrics, objectives, targets, steps and workflows for each category of innovation submissions. Upon submission of a new entry, the system may query the database in order to find similar documents, media, and/or workflows using a data mining module.

The models used for prediction of possible outcomes and the input parameters to those models both carry uncertainty associated with lack of knowledge. One or more embodiments of this invention obtain a set of representative values for the model parameter having uncertain values. The solution includes optimal value for the control variables. In any product or service development, uncertainties are expressed in the form of probability density functions of the decision variables and are systematically propagated through the workflow by generating probability density functions or cumulative distribution functions of the input parameters, and by using multiple runs of mathematical models and simulation tools to thus transform the first set of parameters into output variables with uncertainties. Various graphs, charts, plots, or other visual representation of uncertainty is used to make optimal decisions in identifying the best ideas for further steps (e.g. consideration, implementation, resource allocation and alike).

A further object of the invention is a novel and efficient system and method for multiobjective optimization of innovation and technology management operations and processes under uncertainty. An optimization module modifies the decision variables in an iterative fashion by selecting multiple values from a pre-defined range and distribution. In order to evaluate entries, multiple objective functions are defined and calculated using models and mathematical relationships that can predict outcomes of innovation entries such as development costs, revenue and risks. To calculate the objective functions, users can select from a list of functions provided by the system or define their own objective functions and evaluation criteria. Alternatively, users can utilize a predictive module that uses machine learning techniques and algorithms in order to estimate the desired output value from past project data.

This summary is provided to introduce a selection of concepts in a simplified form that are further described herein. This summary is not indented to identify key or essential features of the claimed subject matter, not is it intended to be used as an aid in determining the scope of the claimed subject matter.

### BRIEF DESCRIPTION OF THE DRAWINGS

A more complete appreciation of the invention and many of the attendant advantages thereof will be readily obtained as the same becomes better understood by reference to the following detailed descriptions when considered in connection with the accompanying drawings; it being understood that the drawings contained herein are not necessarily drawn to scale and that all of the accompanying drawings provide illustrative implementations and are not meant to limit the scope of the various technologies described herein; wherein:

FIG. 1 shows an exemplary demonstration of innovation input providers to an organization.

FIG. 2 shows an innovation management and optimization system and its various components.

FIG. 3 shows various input options for users to enter innovation ideas to the system.

FIG. 4 shows a speech module where audio input is converted to recognized speech.

FIG. 5 shows an input module for the system that receives text, images, videos and audio inputs.

FIG. 6 shows a discovery module which gathers and compares information from internal and external databases and sources.

FIG. 7 shows a clustering module where various types of data are processed and displayed in clusters.

FIG. 8 shows a clustering module and an example of results that can be obtained using this module.

FIG. 9 shows an estimation and prediction module and the steps required for defining parameters and relationships.

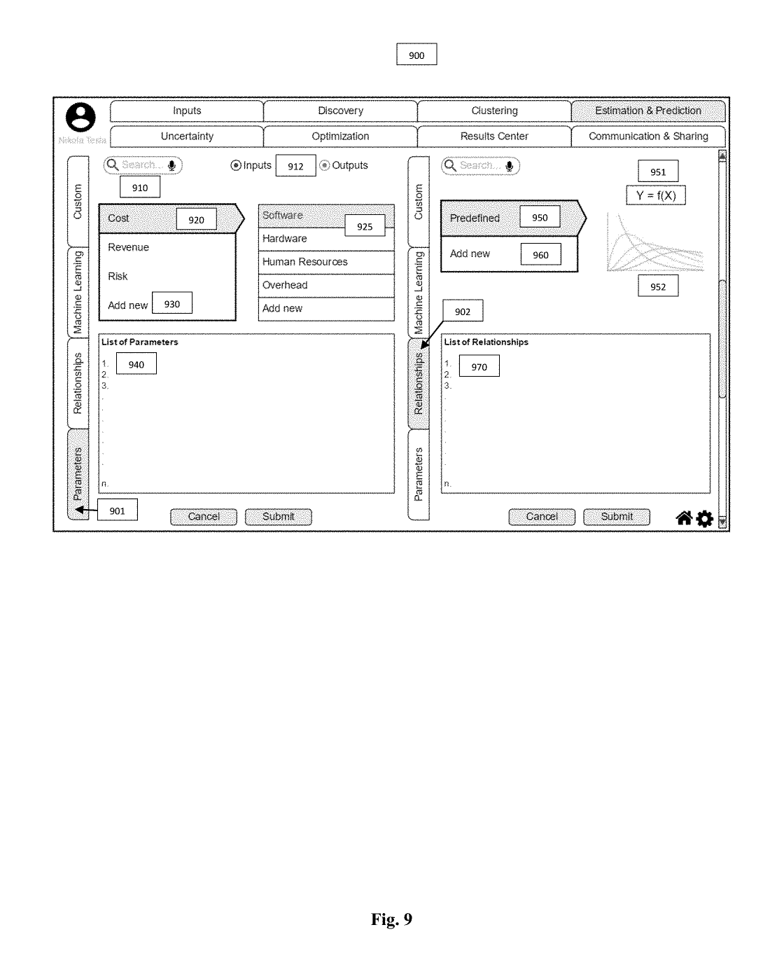

FIG. 10 shows an estimation and prediction module and its machine learning and custom model steps.

FIG. 11 shows an uncertainty module and the steps required to define parameters, ranges, distributions, sampling algorithms and custom workflows.

FIG. 12 shows an exemplary mapping between decision variable space and objective function space.

FIG. 13 shows a workflow to perform multiobjective optimization on innovation entries.

FIG. 14 shows a multiobjective optimization module of the system, demonstrating the steps required to define objectives and perform optimization.

FIG. 15 shows a results module and example of plots obtained after performing uncertainty and optimization steps.

FIG. 16 shows a communication and sharing module to export and share the results.

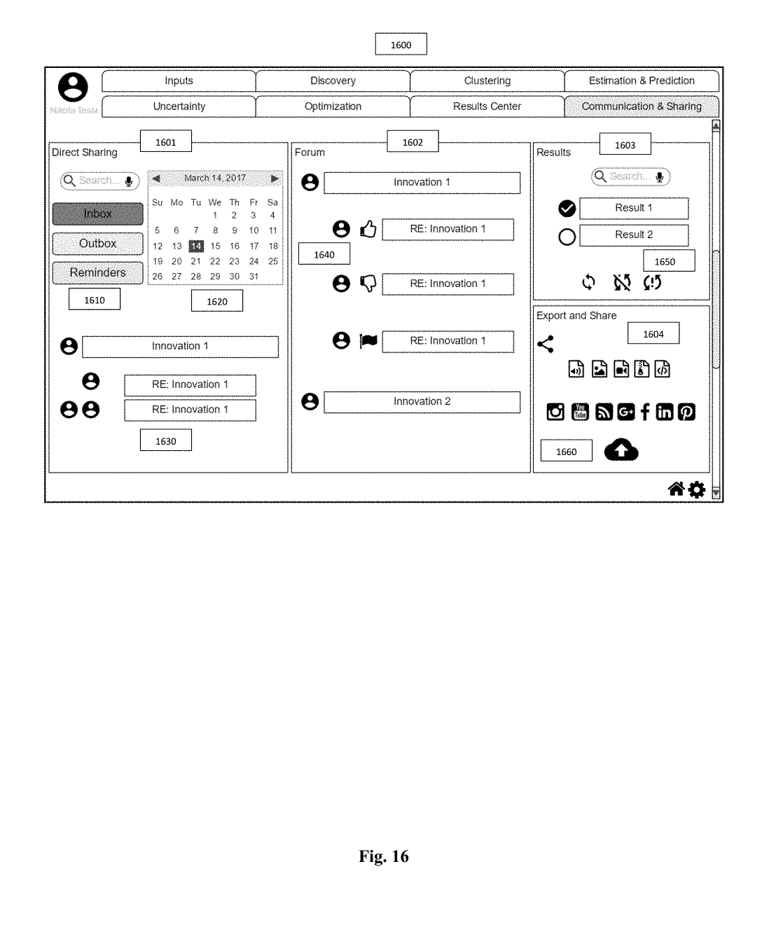

FIG. 17 shows an exemplary architecture of running the innovation management system as a service on the cloud or on premise.

### DETAILED DESCRIPTION OF INVENTION

Specific embodiments will now be described in detail with reference to the accompanying figures. Like elements in the various figures are denoted by like reference numerals for consistency.

In the following detailed description of embodiments, numerous specific details are set forth in order to provide a more thorough understanding of the claims. However, it will be apparent to one of ordinary skill in the art that the claims may be practiced without these specific details. In other instances, well-known features have not been described in detail to avoid unnecessarily complicating the description. While the disclosure is a complete description of the preferred embodiments, it is possible to use various alternatives, modifications and equivalents. These modifications of the embodiments, as well as alternatives embodiments of the invention will become apparent to persons skilled in the art upon reference to the description of the invention. Therefore, the scope of the present invention should be determined not with reference to the description but should, instead, be determined with reference to the appended claims, along with their full scope of equivalents. Any feature described herein, whether preferred or not, may be combined with any other feature described herein, whether preferred or not. In the claims that follow, the indefinite article “A” or “An” referred to a quantity of one or more of the item following the article, except where expressed stated otherwise. The appended claims are not to be interpreted as including means-plus-function limitations, unless such a limitation is explicitly recited in a given claim using the phrase “means for”.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Furthermore, embodiments of the invention may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

### Input and Discovery

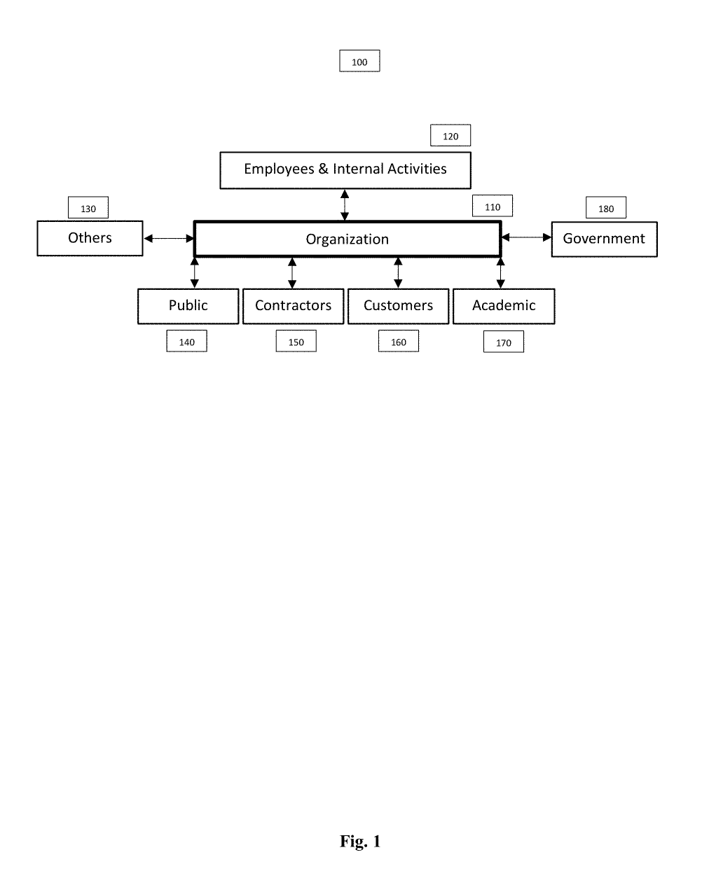

FIG. 1 is a conceptual block diagram 100 illustrating the interaction between an organization 110 and various sources that provide innovation ideas, inputs or feedback. In this disclosure, an innovation entry is defined as any innovation idea related to products and services, research and development processes, enhancement requests, emerging technologies and roadmaps and alike. In a particular example, the input can be provided by an organization's internal employees and research and development activities 120 or through a collaboration with customers 160 and their inputs, government organizations 180, academic and external research organizations 170, public 140, and so on. For example, customers may have operational or technical concerns from using a product. The feedback may be an enhancement or a new feature request. The input may also come from joint innovation workshops held between organizations and their stakeholders. In an alternate embodiment, a government body can replace the organization 110 to seek input from other components such as government employees, other businesses, individuals or public, etc.

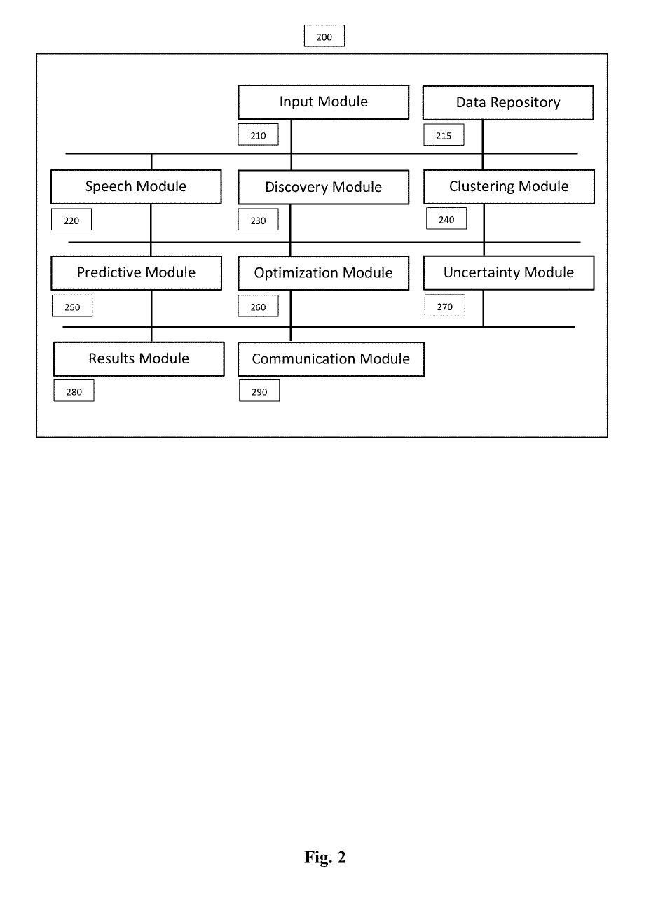

The innovation management system as described in FIG. 2, has several modules including an input module 210, data repository 215, speech module 220, discovery module 230, clustering module 240, predictive module 250, optimization module 260, uncertainty module 270, results module 280 and communication and sharing module 290.

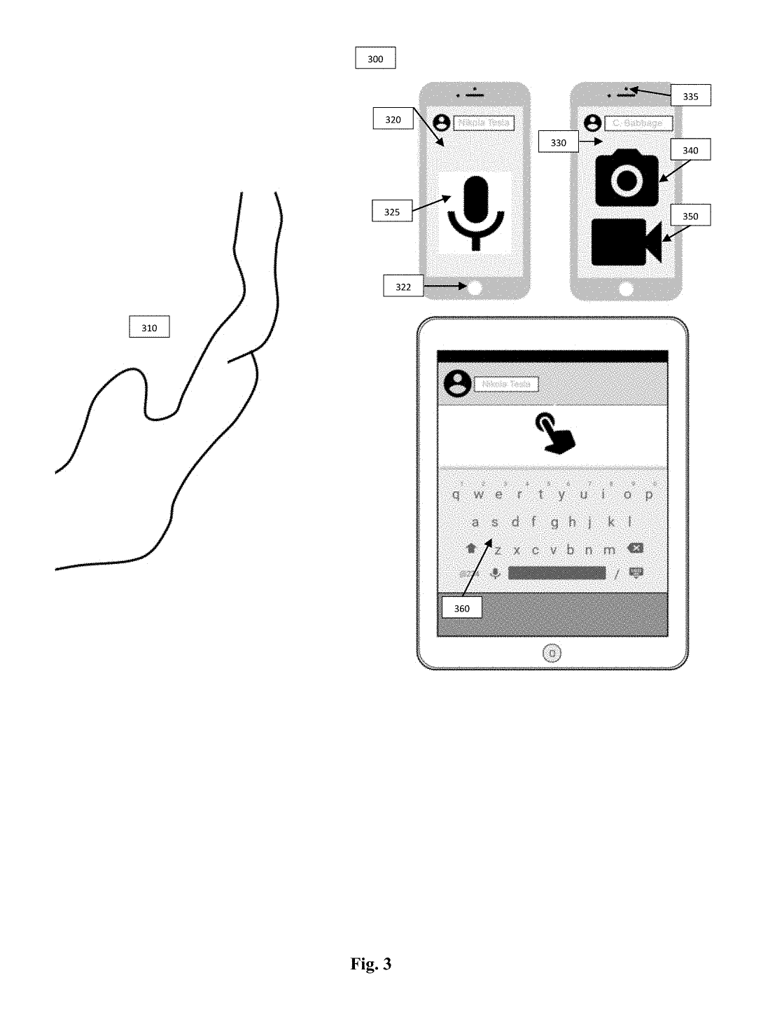

In the first step of the process, the system gathers innovation inputs from different sources. As shown in FIG. 3, users 310 have access to a rich platform supporting text and other forms and sources of media to make new innovation entries. Users are provided with access to system either by registering as individuals or a groups of people. In yet another preferred embodiment, the registration is performed by syncing disclosed innovation system's database with corporate personnel databases using protocols such as Lightweight Directory Access Protocol (LDAP) and alike. In one embodiment, a user utilizing a first device 320 can enter an idea by speaking to a microphone 323, using a voice recording application 325. The device can be a mobile phone or tablet, a desktop computer or a voice recording apparatus. In another embodiment, a user can utilize a second device 330 to record an idea using a camera 335 in a video form 350 or take a picture 340 or a combination of various media forms. In another embodiment, a user can type an idea using a keyboard 360 on a mobile device or desktop unit. The keyboard can be physical or virtual. A user can also use a pen to write on a touch device or utilize any other input mechanism.

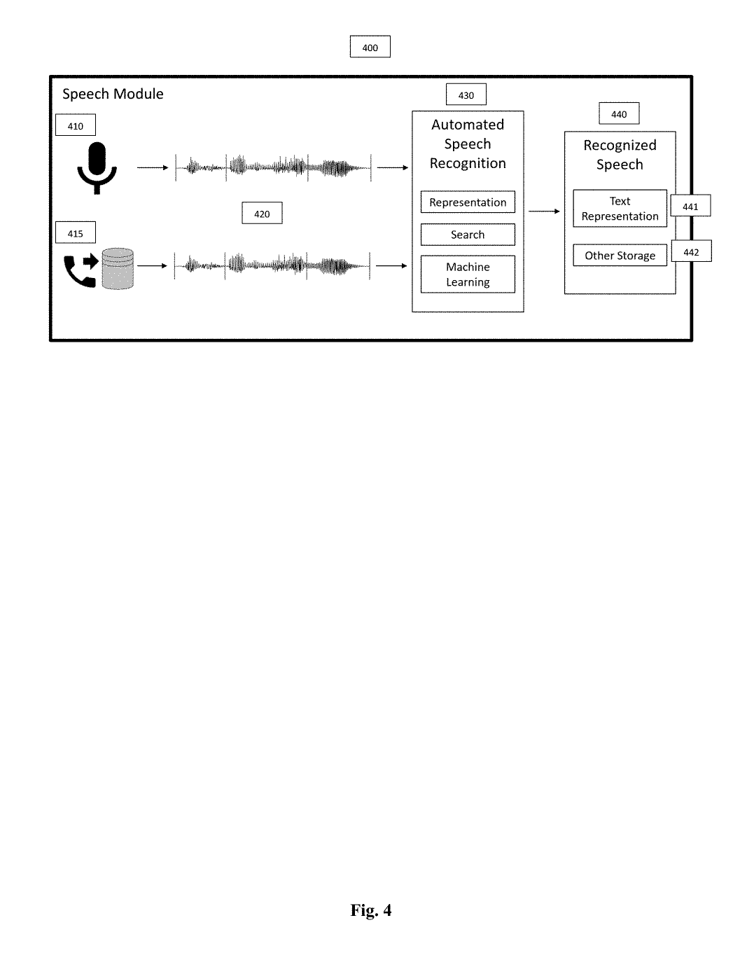

As shown in FIG. 4, if an innovation input is received in audio form, a speech module 400 is used to convert a speech signal 420 to recognized speech 440 using an automated speech recognition algorithm 430. An automated speech recognition system can use a variety of machine learning algorithms including supervised, semi supervised and unsupervised to accomplish this task. In a preferred embodiment, a deep learning neural network is used to perform the machine learning task in speech recognition 430. System 400 consist of an audio file or a link to a file that is directly received from a device 410 or to a database of recorded customer calls to an organization 415 (e.g. called made to the technical support helpdesk). In a preferred embodiment, a recognized speech 440 is considered as a text representation 441. However, a recognized speech also can be stored 442 for future processing or use.

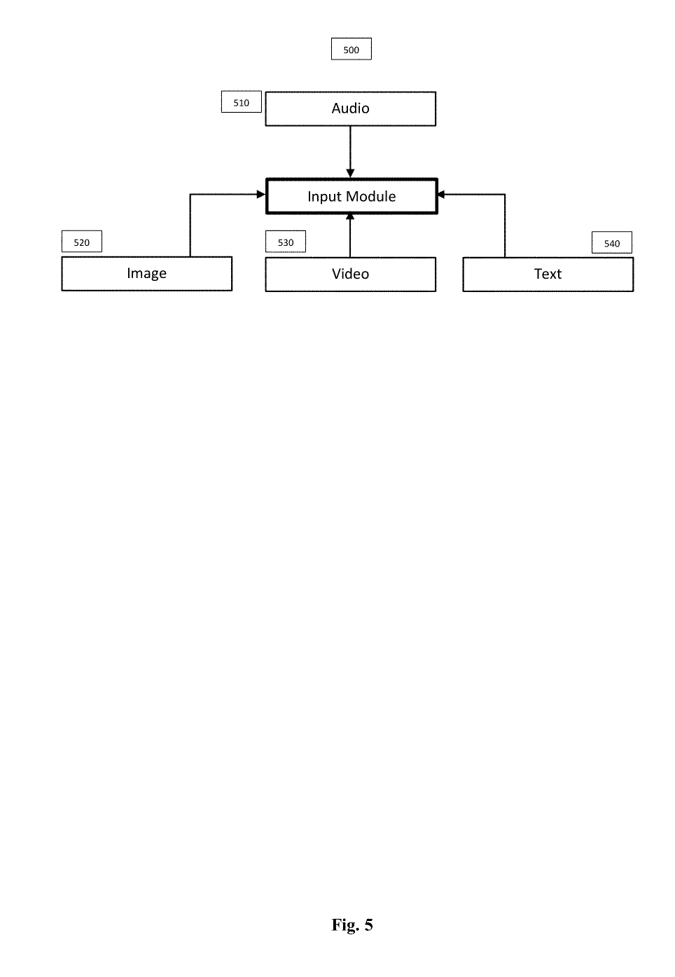

All innovation inputs are then fed to the input module 500 as shown in FIG. 5. The input module collects all innovation inputs in text 540, image 520, video 530 and audio 510 formats in a central repository location.

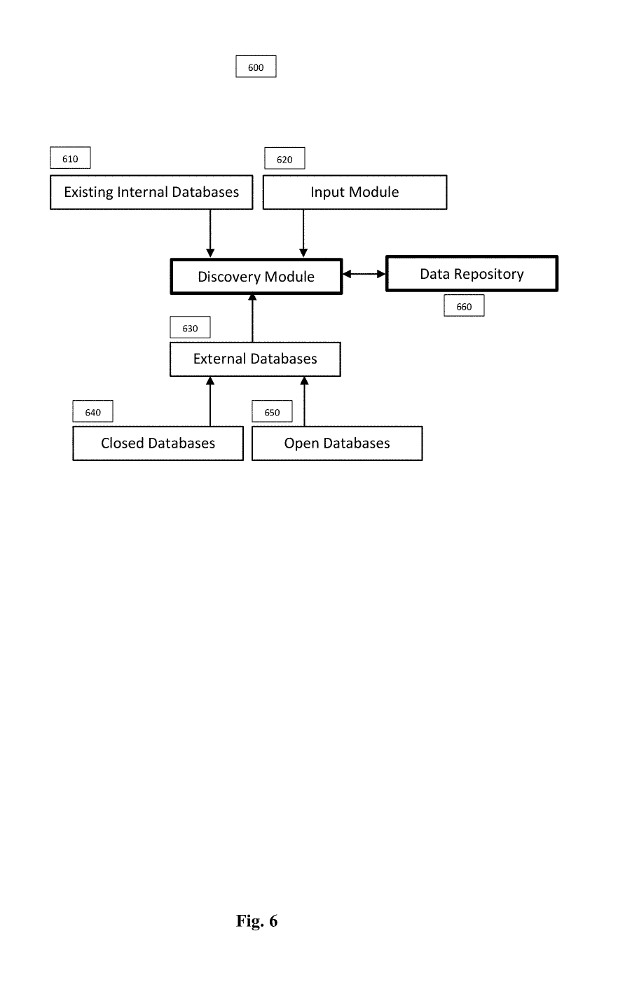

As shown in FIG. 6, a discovery module 600 is used to compare the feed from input module 620 with other existing internal or external databases. The purpose of this step is to locate any information that might be relevant to innovation inputs received by the system; so that the clustering module can identify similarities not only between new innovation entries but also with any existing internal or external information. The discovery module automatically or upon having right privileges and credentials, can access existing internal databases 610 (e.g. previous project reports, ongoing projects, best practices, customer support information, etc.) and/or external databases. External databases 630 can be divided to two groups: open databases 650 such as Google's search engine; and closed databases 640 where special permissions, credentials, protocols, clearances or payments are required to gain access (e.g. scientific databases with paid membership and alike). External databases can also include data from social media to perform social media analytics. The discovery module is linked to a data repository 660 that acts as a central storage facility for all relevant data and information. Users can select all available databases or a partial list of them for the discovery system to connect and use. In a preferred embodiment, the discovery module then stores all of the retrieved information in the data repository.

### Data Mining and Clustering

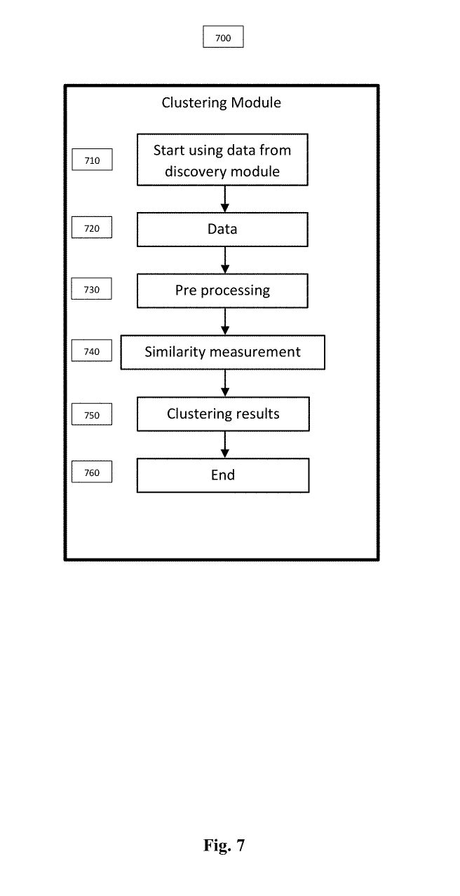

The automated data mining and clustering system 700 can indicate whether a similar innovation submission exists in internal or external systems. As shown in FIG. 7, the system follows a workflow that requires no manual annotation or analysis by a user or group of users. The objective of system 700 is to automatically analyze structured and unstructured documents to gain meaningful information and insights. It is also capable of grouping similar innovation entries together or assigning them to a predefined category or person (e.g. engineering, finance, supply chain, IT, management, etc.).

The system 700 starts by using data from discovery module 710, with users having ability to select all or a portion of available data 720. A preprocessing operation 730 can be performed to clean and prepare data. Then a clustering algorithm perform a similarity measurement 740 between ingested documents and files and produces clustering results 750, before ending the workflow 760. In a preferred embodiment, text entries can be preprocessed using tools such as tokenizing, stemming and part-of-speech. For text files, a variety of supervised and unsupervised machine learning algorithms can be used. The text mining methods may include but not limited to concept-based term and sentence analytics, corpus-based concept analysis, concept-based similarity measure. The clustering can be based on distances among cluster members, dense regions of data space, intervals or according to statistical distributions of data. Alternatively, the clustering can be topic-based, content-based or media-based. Furthermore, difficulty of text document to read and understand can be used to classify them. Several readability metrics can be utilized to understand the readability of documents. These include but not limited to Gunning fog index, SMOG index, Coleman-Liau index, Flesch Grade Level, Automated Readability Index (ARI), etc. The preferred readability index in this disclosure is the Flesch test.

The preferred method to be used with innovation documents in this disclosure is the Sparse Topical Coding (STC) algorithm introduced by Zhu and Xing (2011). The algorithm can be coupled with Support Vector Machine (SVM) for supervised classification. Other methods can also be used to perform clustering of innovation entries. For example in dealing with several documents that discuss the same set of topics in varying degrees of detail, a Latent Dirichlet Allocation (LDA) with or without variational estimation may be applied to reveal a document's underlying structure and the discussed topics. LDA can be considered as a joint probability distribution over observed and hidden random variables random variables. In a data mining context, words and documents are the observed variables while the topic structure is considered as a hidden variable. For example, an innovation submission may contain descriptions of services that will be offered or implementation details. In LDA, a topic is defined as a distribution of words over a vocabulary. Based on this definition, the algorithm works towards understanding the topics in a document that exhibit a similar pattern to vocabulary. Other variation of this technique is called Spatial Latent Dirichlet (SLD.)

The preferred algorithm for clustering images, audio and video is deep Convolutional Neural Networks (CNN). The algorithm identifies similar images, audio files and video recording and groups them together.

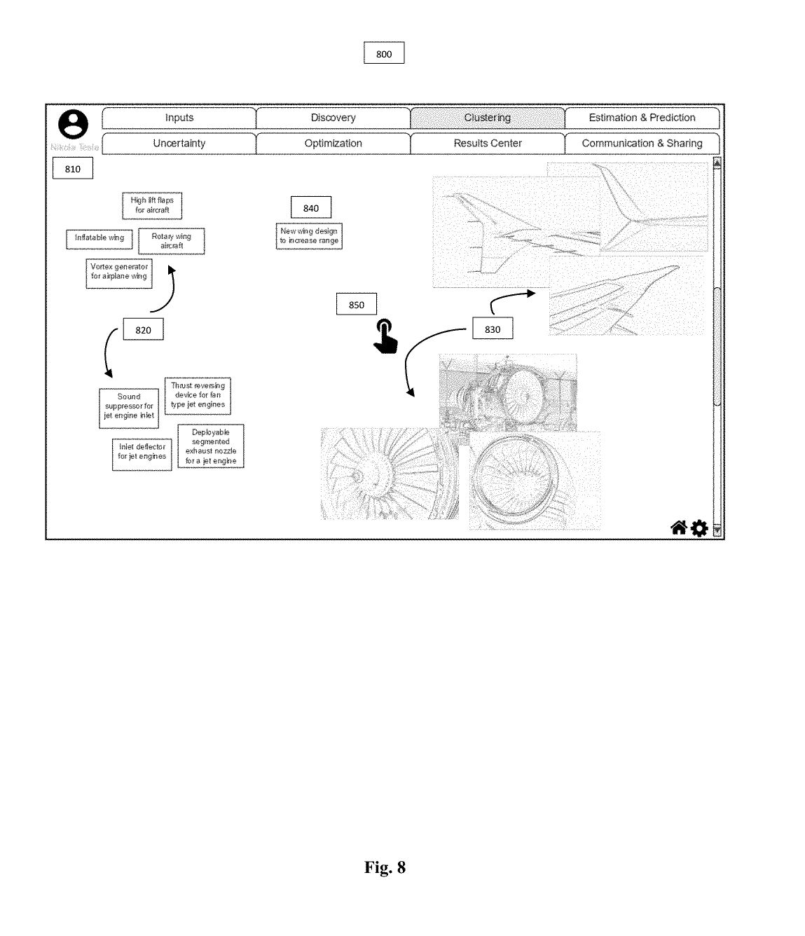

As shown in FIG. 8, users 810 perform the clustering and visualize the results using system 800. Visualization of text clusters 820 aims to show relationships between innovation entries in different groups so that users gain a quick and efficient understanding of the topics, themes, trends, similarities, sentiments and other characteristics. This enables decision makers to quickly organize, compare and choose appropriate innovation entries for further analysis. As an example, 820 shows clustering of innovation documents in two groups; one focusing on aircraft flaps and another group related to jet engine design. In yet another preferred embodiment, word clouds are used to show the keyword frequencies used in a document corpus. A similar visualization concept is used for image and video based files 830. For example, the disclosed clustering system has separated images related to aircraft wing design from images related to jet engine design. Once a new innovation 840 is submitted, the system automatically moves the submission to appropriate category based on similarity of the new innovation with existing groups.

Although the disclosed system is designed for automated classification and clustering, user input can be provided, if desired. Once the clustering algorithm has finished processing the entries and the results are displayed 800, users can select one or multiple innovation entries and rearrange 850 the entries to appropriate groups. User interaction can also be provided during the progress of clustering algorithms in an interactive manger.

### Estimation and Prediction

The first step in the estimation and prediction module 900 is to define input parameters and outputs or targets 901. Estimating time, effort and associated costs required to implement an innovation entry is of paramount importance in innovation management. The system provides an extensive list of variables and objectives that can be added using an interface by selecting the appropriate category in 912. In a preferred embodiment, there are 3 general categories (i.e. cost, revenue, risk) as presented in 920 with each main category having a sub list of items 925. Users can add new categories in 930 by manually entering an item. In any stage, users can search for parameters by typing in the search box 910 or through a voice command. The full list of specified parameters is displayed in 940.

A user can define the relationship 902 between input parameters and outputs directly using mathematical functions 951, or utilizing a library of graphical representations 952 with an option for manual editing, or importing new sets of relationships 960. For example, sales of a product will continue to grow until a market saturation is observed. The process can be described using historical sales data and probability distributions (e.g. Gaussian) to indicate early adoption, general acceptance and the decline due to new technologies or market saturation. The preferred distribution to model this phenomena in this disclosure is the Erlang distribution. This distribution benefits from the same idea of Gaussian distribution but has a definite sales starting point in the curve, instead of having a tail in the normal distribution. In yet another method to define input-output relationships, users can benefit from a rule-based system that represents the relationships using a set of if-then rules. Furthermore, it is possible to benefit from a fuzzy rule-based system for this purpose. A complete list of all relationship that are defined using any of the above approaches is displayed in 970.

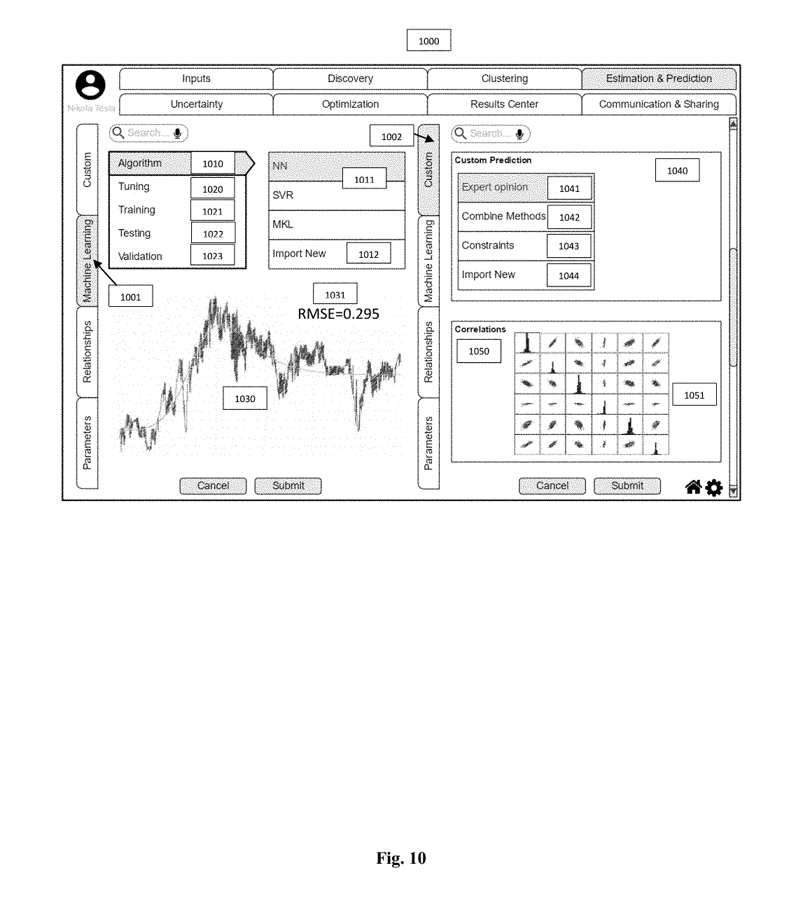

Historical innovation data can be utilized by a machine learning algorithm to produce an estimation and prediction model instead of an equation or a distribution as it was described in 902. For this purpose, the system provides a machine learning module 1001 as shown in FIG. 10. The machine learning module receives the historical data from the discovery module and builds an estimation model using various artificial intelligence algorithms. For this purpose, users first select algorithm type in 1010. The preferred machine learning algorithm in this disclosure is neural networks 1011. Other algorithms that can be used for this purpose include support vector regression (SVR) and Multiple Kernel Learning (MKL). Users can also import new machine learning algorithms 1012 that are trained and tested outside the disclosed system. If the machine learning algorithm has tuning parameters, users should select the appropriate tuning parameters 1020 of the algorithm and conduct a training exercise 1021. It is also possible to automatically select and/or tune appropriate hyper-parameters of the machine learning algorithm. The trained model in this stage can be tested 1022 against data that were left aside during the training stage. If the results are satisfactory using this blind test, users can proceed to utilize the trained model with validation data 1023. The results of training, testing and validation are displayed using graphical representations 1030 and error indicators 1031. The preferred error measurement used in this disclosure is root mean square error (RMSE).

In some innovation management problems, it might be beneficial to use a hybrid approach. In many cases, it may not be practical to define input-output relationships. In these scenarios, an experienced user may be to look at previous projects, either locally or globally and provide an expert judgment on estimated cost and duration 1041. Another possibility is to combine several methods 1042; for example expert opinion in conjunction with mathematical models or a hybrid solution based on analytical and machine learning estimations. In this process, user may also provide additional constraints 1043. The constraint, for example, can be based on user knowledge to eliminate solutions that are mathematically correct but not possible to implement in a real world scenario. Users can also import new custom models 1044 that do not fall under the categories mentioned above.

Input variables in an estimation problem may be correlated. As described in FIG. 10, in order to deal with parameter correlations in innovation entries, copulas 1050 are used as the preferred method in this disclosure. Copulas provide a mechanism to model correlated multivariate data by specifying marginal univariate distributions. Example copulas that can be used include Gaussian, Clayton, Gumbel, Frank and Student 2. More detailed description of copulas is given in Smith (2011) and Notle (2011). A visual representation of the correlations 1051 is also provided to aid the decision making process.

### Uncertainty Analysis

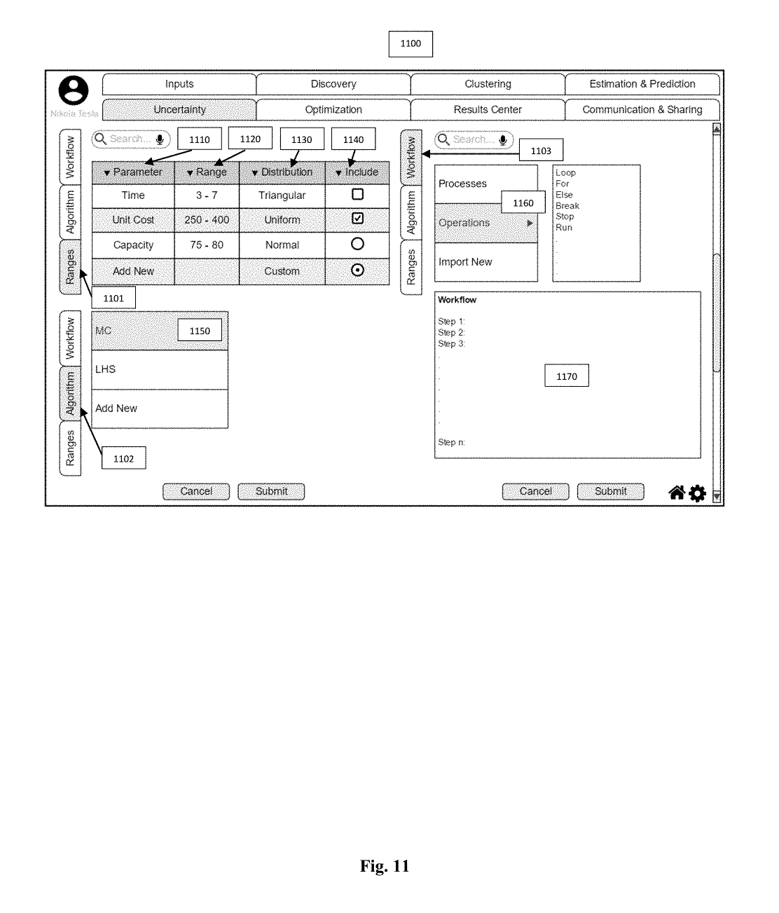

In innovation management, the input and output variables of an entry (e.g. future sales, development time, etc.) may not be exactly known and therefore, they are subject to uncertainty. In other words, parameters and their values can be ill-defined. This uncertainty is then propagated to objectives (e.g. cost, revenue, risk), resulting in a range of possible outcomes instead of a single prediction. Innovation entries to the system are represented using plurality of input parameters with uncertain values. These representative values capture underlying variation in the model parameters. System and method 1100, as shown in FIG. 11, addresses this uncertainty by sampling from a range and a probability distribution for input variables and examining the impact on outputs.

The process starts in 1101 with defining uncertain parameters 1110, a range for parameters 1120 and a probability distribution type 1130, covering this range. The range for input parameters can be continuous, discrete or selected from a list of numbers supplied by the user. Example distribution types that are available for sampling in the system include uniform, normal, Erlang, triangular, trapezoidal, Bates, Beta, etc. Users can also define a custom distribution that fits well for a specific dataset. The system provides an option 1140 to select or deselect parameters that are considered in the uncertainty studies. This is useful if users want to return to this step after seeing the results of an uncertainty and sensitivity study and modify the input parameters and/or ranges and distribution types.

The process is followed by selecting the sampling algorithm 1102. In one or more embodiments of the invention, a set of representative values may be produced by sampling from a probability density function. Monte Carlo Simulation (MCS) is preferably used under the present disclosure to perform uncertainty and sensitivity analysis. To perform MCS, a probability distribution function is preferably selected for each of the parameters that are going to be analyzed. The distribution should usually cover the range of the parameter based on user experience or data available in a database. Then the predictive model defined in the previous stage is executed thousands of times, each time randomly selecting a combination of the values of the parameters from their corresponding probability distribution. The result of this analysis is a probability distribution function of the output. In yet another embodiment, sampling of the space can be performed using Hamiltonian Monte Carlo (HMC), No-U-Turn Sampler (NUTS), Differential Evolution Adaptive Metropolis (DREAM), and random walk (RWM), etc.

Innovation management can be a complex process with several steps required to achieve a specific objective. The disclosed system and method provides an option to define a custom workflow in 1103. Users can write a custom workflow that should be executed during an uncertainty quantification study. A range of options 1160 is includes in the system including a library for processes that are common in innovation management and a library of programming operations that can link multiple processes. Users also have the option to import a completely new workflow that is designed outside the disclosed system and use it in the uncertainty study. The defined workflow is displayed in 1170 for a better understanding of the underlying processes and operations.

### Multiobjective Optimization of Decision Variables

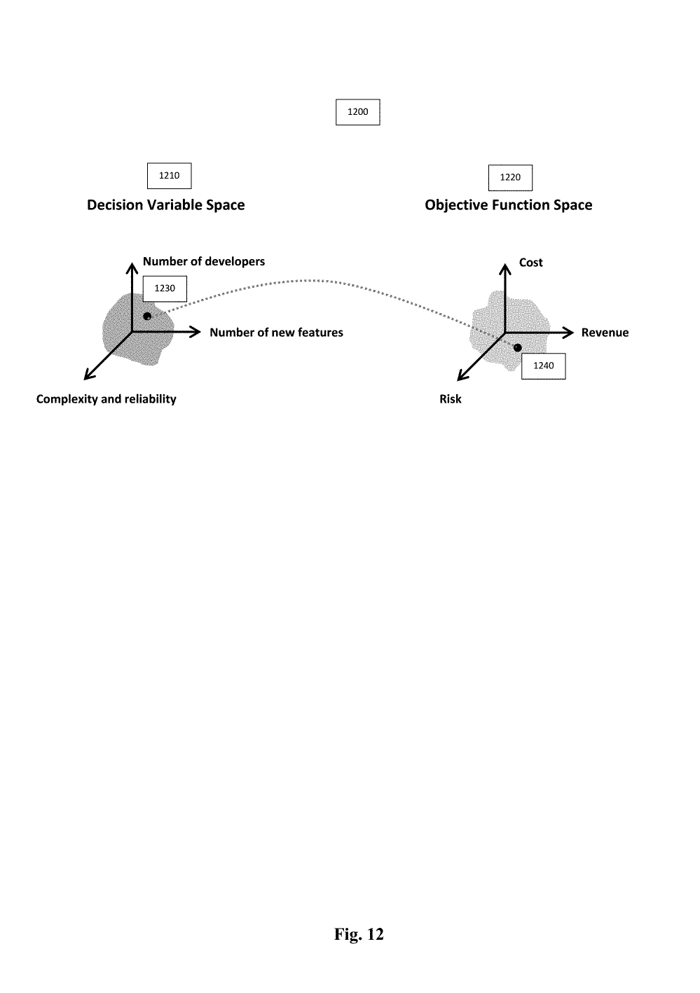

Real-life optimization problems deal with multiple objectives which are often conflicting. The multiobjective optimization field is concerned with finding optimal solutions in the presence of more than one objectives or goals in the decision space. The optimality can be a minimized value if a cost function is considered or a maximized value if the objective function is defined as a utility function. As shown in FIG. 12, there is a mapping between decision variable space or search variables 1210 and objective function or solutions space 1220 in a multiobjective setup where a solution in the decision variable space 1230 has a corresponding multi-dimensional objective function value 1240. In a general form, the problem can be described using the following equation:

$$\begin{matrix}Maximize / Minimize {f}_{m} ( x ) , & m = 1 , 2 , … , M \\ Subject to {g}_{j} ( x ) \geq 0 , & j = 1 , 2 , … , J \\ {h}_{k} ( x ) = 0 , & k = 1 , 2 , … , K\end{matrix} \}$$

where x is a decision vector of n variables: x=(x₁, x₂, . . . , xₙ) and the number of objective functions in the problem is denoted with M n the problem which can be minimized or maximized: f(x)=(f₁(x), f₂(x), . . . , f_{M}(x)). The problem can come with a set of constraints (gⱼ(x) and hₖ(x)) that determine the set of feasible solutions.

In a multiobjective optimization context, our aim is not to find a single solution but to explore a set of compromises among the objectives. Therefore, it is necessary to define a dominance concept referred to as Edgeworth-Pareto optimality or more commonly known as Pareto optimality. The concept states that if there is an alternative solution (A) that is at least equal to (B) in terms of all objective functions, and if (A) is strictly better than (B) for at least one of the objective functions, then A dominates B (A≦B) The following equation shows the Pareto optimality concept.

fₘ(A) [symbol] fₘ(B) for all m=1,2, . . . ,M (A is no worse than B for all objectives) 1)

AND

fₘ(A) [symbol] fₘ(B) for at least one m=1,2, . . . ,M (A is better than B for at least one objective) 2)

A solution is called Pareto optimal if there is no feasible solution that can optimize an objective without causing a simultaneous degradation in at least another objective. We follow two main objectives in solving any multiobjective optimization; we must obtain solutions as close as possible to the true Pareto front and furthermore, these solutions must be as diverse as possible.

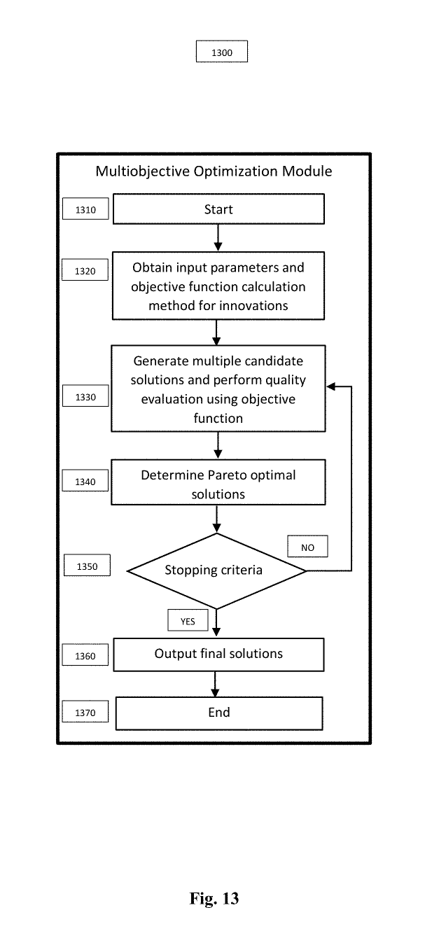

FIG. 13 shows the workflow 1300 used in this disclosure to perform multiobjective optimization on decision variables of innovation entries and projects. The system starts 1310 by obtaining input parameters of innovation entries and corresponding objective function calculation method 1320. A multiobjective optimization algorithm generates multiple candidate solutions in each iteration. Each proposed solutions fitness and quality is evaluated using objective functions. Based on fitness scores, Pareto optimal solutions in each generation are identified 1340. In the next stage, stopping criteria for optimization is checked 1350. The stopping criteria can be the maximum number of iterations, a threshold for objective function values, a predetermined improvement of objective function values in two consecutive iterations or a combination of these criteria. If stopping criteria is met, the system outputs final solutions and corresponding Pareto front 1360 and ends the workflow 1370. If stopping criteria are not met, the system goes back to step 1330 and generates the next set of solutions.

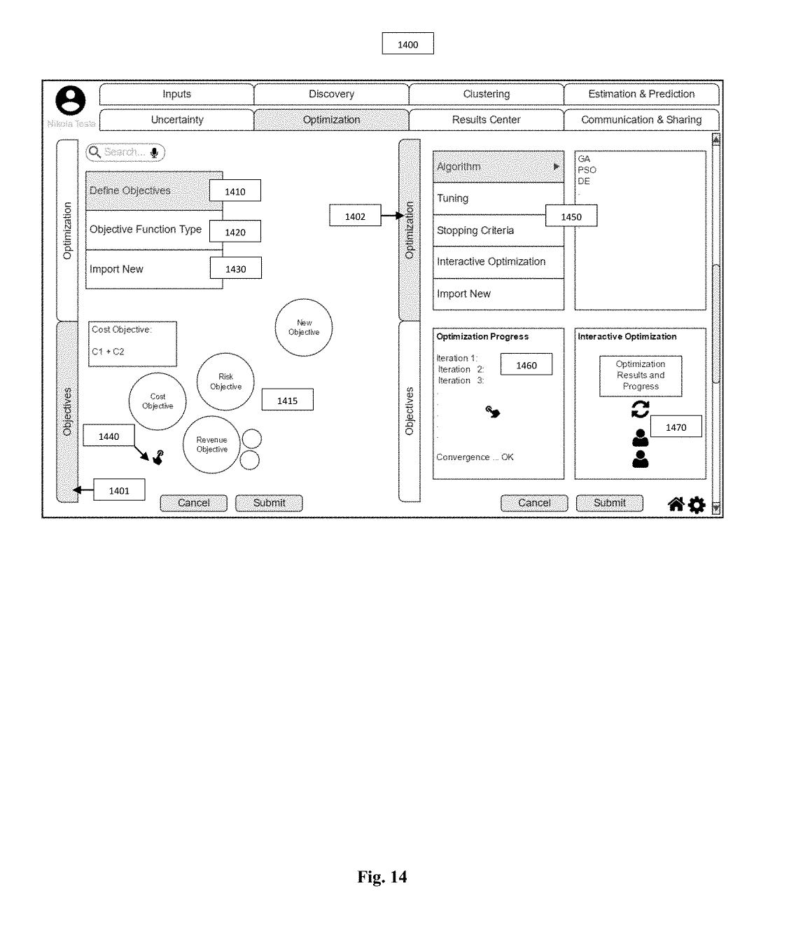

FIG. 14 shows the process 1400 for defining objective functions 1401 and selecting the optimization algorithm type and parameters 1402 for multiobjective optimization of innovation entries.

An optimization problem includes a set of objectives (multi objective) and constraints that are defined in 1410 and the objective function type 1420. Constraints are limits on possible feasible configurations. In other words, constraints limit which configurations are feasible configurations. Users also have the ability to define and import new objective function definitions 1430 if the specific objective function is not already provided in system 1400's library.

Furthermore, a visual representation of the defined objective functions is given in 1415 where users can see definition of objective functions in each group and manipulate them 1440, should it be necessary.

In the next step, users should select the optimization algorithm, tuning parameters and stopping criteria in 1450. In one or more embodiments, an optimization algorithm aims to find a single best or set of best solutions from the set of all feasible solutions. In other words, a solution is a particular value for each control variable representing a configurable element. Users should specify if they wish to perform an interactive optimization and if they would like to import a new optimization algorithm which is not present in system's library. Evolutionary algorithms are an attractive option for solving multiobjective optimization problems as they work with a population of solutions and can provide an ensemble of Pareto optimal solutions for decision making purposes. These algorithms themselves are divided to two groups of non-elitist based methods and elitist-based algorithms. The first group does not offer a mechanism to systematically preserve the elite solutions in each generation. Examples of non-elitist based approaches include Multiobjective Genetic Algorithm (MOGA) and Nondominated Sorting Genetic Algorithm (NSGA). On the other hand, elitist based approaches tend to favor survival of the elite solutions of each generation to the next one. Some of the algorithms belonging to this group include Pareto-Archived Evolutionary Strategy (PAES), elitist-based NSGA-II algorithm, estimation of distribution algorithms and particle swarm optimization. The preferred algorithm in this disclosure for multiobjective optimization of innovation entries is Multiobjective Differential Evolution.

The system shows the optimization progress 1460 using several metrics including iteration numbers, current iteration's best objective function values, overall best objective functions and so on. Furthermore, in multiobjective optimization, solution diversity and Pareto optimal coverage is also important and is displayed here.

As shown in FIG. 14 and in yet another embodiment, users may have an interactive optimization experience 1470 where a decision maker interacts with multiobjective optimization algorithm by providing feedbacks while optimization is still in progress. The preferred method in this disclosure is interactive multiobjective particle swarm optimization introduced by Hettenhausen et al. (2010). Other methods of interactive optimization that can be utilized include trade-off based algorithms, reference point approaches and classification-based methods.

### Results Module

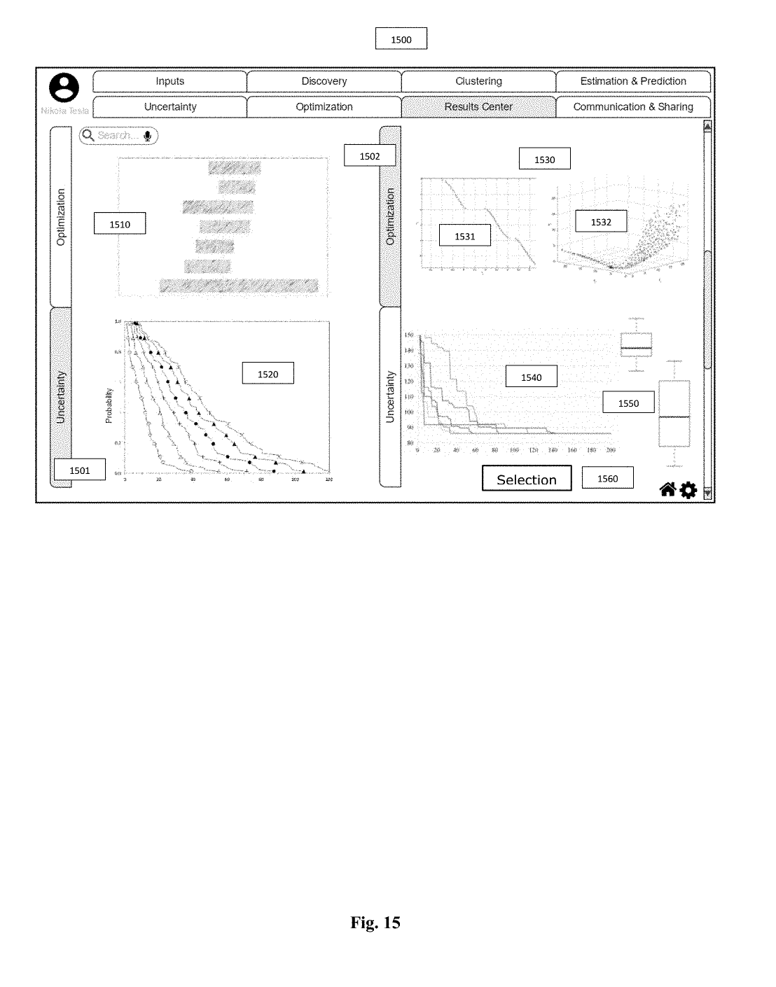

The results module 1500, as shown in FIG. 15, is a central location to display results of running uncertainty 1501 and optimization 1502 modules. For example, Tornado plot 1510 shows results of Monte Carlo sampling for seven parameters. Another result of an uncertainty study is the probability distribution for outputs which is displayed as exceedance probabilities (Px) in 1520. The same results can also be presented as cumulative probabilities. For optimization results, a variety of plots can be utilized to understand the process of minimizing or maximizing objective functions and final results. Example of these plots include Pareto fronts 1530 displayed in two variants of discontinuous 1531 and continuous 1532. The progress of optimization can be checked using convergence plots 1540. In yet another embodiment, spread of solutions or objectives can be visualized using boxplots 1550. A selection mechanism 1560 is provided in this module for users to select one or more optimal solutions among population of solutions for implementation or further analysis.

### Communication and Sharing

The purpose of communication and sharing module 1600 is to provide a platform for system users to share results with internal or external people. The system includes a direct sharing module 1601 as a mailbox system with component such as inbox, outbox, reminders 1610 and a calendar function 1620. Innovation entries that are handled through the direct sharing module are displayed in a separate panel 1630 with options to read, reply, forward and flag communications. The sharing module also contains a forum like panel 1602 where users can openly discuss innovation entries by providing simple feedback of like or dislike, or a more detailed feedback using various media forms including text, image, audio or video 1640. Communication and sharing module is in direct sync 1650 with the results module using a separate panel 1603 where users can search for specific results and select a single or multiple plots and metrics to be shared with others. Another panel 1604 provides various options to export results to external platforms and services such as social media.

In one or more embodiments and at various stages of the method, the system may interact with the user through the user interface to obtain additional information including new decision variables, modification of objective function, introduction of new metric to consider in solving the optimization problem, new stopping criteria for the optimization algorithm, new uncertainty range for sampling purposes, new probability distribution, and so on.

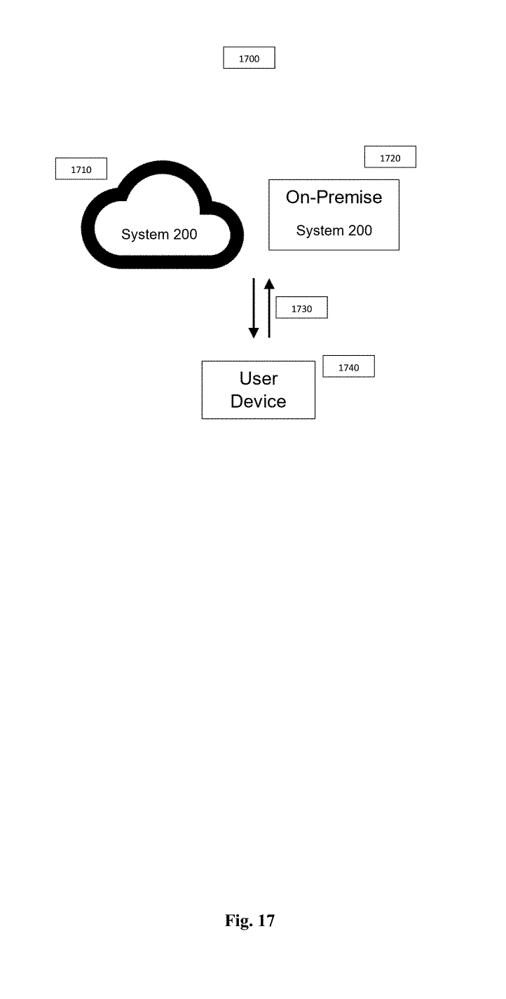

Further, as shown in FIG. 17, one or more elements of the aforementioned computing and storage system 200 may be located at a remote location and connected to the other elements over a network 1730 as a cloud computing environment 1710 or as on premise solutions 1720. User devices 1740 can connect to the system in order to provide requests and receive the transmitted results. The service can be performed as a software as a service (SaaS), platform as a service (PaaS), infrastructure as a service (IaaS) or a combination of these options. The network 1730 can be a local area network (LAN), a wide area network (WAN) such as the Internet, mobile network, or any other type of network. Further, embodiments may be implemented on a distributed system having a plurality of nodes, where each portion may be located on a different node within the distributed system. In one embodiment, the node corresponds to a distinct computing device. The node may correspond to a computer storage, processor, micro-core of a computer processor with shared memory and/or resource.

Software instructions in the form of computer readable program code to perform embodiments may be stored, in whole or in part, temporarily or permanently, on a non-transitory computer readable medium such as a CD, DVD, storage device, flash memory, physical memory, or any other computer readable storage medium. Specifically, the software instructions may correspond to computer readable program code that when executed by a processor(s), is configured to perform embodiments.

What is claimed is:

1. A method of innovation management and optimization under uncertainty, the method comprising:
receiving, at one or more processors, a submission including one or more innovation entries, wherein each innovation entry is related to a product, service, process, experience, or strategy;
executing a sparse topical coding (STC) algorithm on the innovation entries to output respective topics described in the innovation entries;
comparing, by the one or more processors performing one or more of text and vocabulary matching, the topics of the innovation entries with data of existing submissions stored in a database to identify matching topics between a received submission and a stored submission;
for each received submission, based on at least one topic of a received innovation entry matching at least one topic of the stored submission, clustering the received submission with the stored submission;
outputting a visual representation of the clustering that illustrates relationships between different groups of the submissions of the clustering, wherein a group includes submissions focused on a same type of product, service, process, experience, or strategy; and
assigning a group of the submissions of the clustering to a predefined category of the innovation management.

2. The method of claim 1, wherein the innovation entries comprise an image, and wherein comparing the innovation entries with the data of existing submissions stored in the database comprises matching the image with images of the data of existing submissions stored in the database by executing convolutional neural networks.

3. The method of claim 1, further comprising:
determining an implementation cost to implement each of the submissions of the clustering; and
selecting a submission of the submissions of the clustering with a minimum implementation cost.

4. The method of claim 1, further comprising:
determining an implementation input to implement each of the submissions of the clustering, wherein each implementation input includes a cost, a revenue, and a risk parameter; and
for each submission of the clustering, determining a relationship between the implementation input and an implementation output, wherein the relationship is defined by a machine learning model.

5. The method of claim 4, further comprising determining the revenue using historical sales data and a probability distribution to estimate the revenue.

6. The method of claim 1, wherein receiving the submission comprises receiving one or more innovation entries represented using input parameters related to the product, service, process, experience, or strategy and associated with uncertain values, wherein the uncertain values are indicative of underlying variation in the input parameters, and the method further comprises:
performing an uncertainty quantification routine to obtain probabilistic estimates of a cost and a revenue to implement the submission.

7. The method of claim 1, further comprising:
determining an implementation input to implement each of the submissions of the clustering, wherein each implementation input includes a cost, a revenue, and a risk parameter; and
for each submission of the clustering, determining a relationship between the implementation input and an implementation output, wherein the relationship is based on a machine learning prediction model.

8. The method of claim 1, further comprising:
for each received submission, determining uncertain parameters to implement the submission, a range for the uncertain parameters, and a probability distribution type covering the range;
receiving a selection of a sampling algorithm including a probability density function;
executing the sampling algorithm on the uncertain parameters multiple times, each time randomly selecting a combination of values of the uncertain parameters from their corresponding probability distribution type; and
outputting a probability distribution function indicating estimates of a cost and a revenue to implement the submission.

9. The method of claim 8, further comprising calculating indices to identify which uncertain parameter will most reduce a performance metric uncertainty.

10. The method of claim 1, further comprising:
for each submission of the clustering, receiving an objective function calculation value for predicting an outcome of the submission including details of costs, revenue, and risks;
generating multiple candidate solutions, for each submission, using the objective function calculation value; and
identifying a Pareto optimal solution from among the multiple candidate solutions.

11. The method of claim 1, wherein the one or more processors is in a computing device, and the method further comprises:
establishing communication between a mobile device and the computing device;
receiving input at the mobile device;
conveying data generated in response to at least one innovation entry performed at the computing device via the mobile device; and
performing at least one operation at the mobile device at least partially based on the data generated by the computing device.

12. A computer system comprising:
one or more processors; and
a memory coupled to the one or more processors storing a set of computer-readable instructions, that when executed by the one or more processors, cause the one or more processors to perform functions comprising:
receiving a submission including one or more innovation entries, wherein each innovation entry is related to a product, service, process, experience, or strategy;
executing a sparse topical coding (STC) algorithm on the innovation entries to output respective topics described in the innovation entries;
comparing, by the one or more processors performing one or more of text and vocabulary matching, the topics of the innovation entries with data of existing submissions stored in a database to identify matching topics between a received submission and a stored submission;
for each received submission, based on at least one topic of a received innovation entry matching at least one topic of the stored submission, clustering the received submission with the stored submission;
outputting a visual representation of the clustering that illustrates relationships between different groups of the submissions of the clustering, wherein a group includes submissions focused on a same type of product, service, process, experience, or strategy; and
assigning a group of the submissions of the clustering to a predefined category of the innovation management.

13. The system of claim 12, wherein the innovation entries comprise an image, and wherein comparing the innovation entries with the data of existing submissions stored in the database comprises matching the image with images of the data of existing submissions stored in the database.

14. The system of claim 12, wherein the functions further comprise:
determining an implementation cost to implement each of the submissions of the clustering; and
selecting a submission of the submissions of the clustering with a minimum implementation cost.

15. The system of claim 12, wherein the functions further comprise:
for each received submission, determining uncertain parameters to implement the submission, a range for the uncertain parameters, and a probability distribution type covering the range;
receiving a selection of a sampling algorithm including a probability density function;
executing the sampling algorithm on the uncertain parameters multiple times, each time randomly selecting a combination of values of the uncertain parameters from their corresponding probability distribution type; and
outputting a probability distribution function indicating estimates of a cost and a revenue to implement the submission.

16. A non-transitory computer readable medium, having stored therein instructions, that when executed by one or more processors cause the one or more processors to perform functions comprising:
receiving a submission including one or more innovation entries, wherein each innovation entry is related to a product, service, process, experience, or strategy;
executing a sparse topical coding (STC) algorithm on the innovation entries to output respective topics described in the innovation entries;
comparing, by performing one or more of text and vocabulary matching, the topics of the innovation entries with data of existing submissions stored in a database to identify matching topics between a received submission and a stored submission;
for each received submission, based on at least one topic of a received innovation entry matching at least one topic of the stored submission, clustering the received submission with the stored submission;
outputting a visual representation of the clustering that illustrates relationships between different groups of the submissions of the clustering, wherein a group includes submissions focused on a same type of product, service, process, experience, or strategy; and
assigning a group of the submissions of the clustering to a predefined category of the innovation management.

17. The non-transitory computer readable medium of claim 16, wherein the functions further comprise:
determining an implementation input to implement each of the submissions of the clustering, wherein each implementation input includes a cost, a revenue, and a risk parameter; and
for each submission of the clustering, determining a relationship between the implementation input and an implementation output, wherein the relationship is defined by a machine learning model.

18. The non-transitory computer readable medium of claim 16, wherein the functions further comprise determining the revenue using historical sales data and a probability distribution to estimate the revenue.

19. The non-transitory computer readable medium of claim 16, wherein the innovation entries comprise an image, and wherein comparing the innovation entries with the data of existing submissions stored in the database comprises matching the image with images of the data of existing submissions stored in the database by executing convolutional neural networks.

20. The non-transitory computer readable medium of claim 16, wherein the functions further comprise:
determining an implementation cost to implement each of the submissions of the clustering; and
selecting a submission of the submissions of the clustering with a minimum implementation cost.
